(19) United States
(12) Patent Application Publication
(10) Pub. No.: US 2019/0351533 A1
(43) Pub. Date: Nov. 21, 2019

(54) UNIVERSAL PLIERS

(71) Applicant: PEI-CHING CHANG, Taichung City (TW)

(72) Inventor: PEI-CHING CHANG, Taichung City (TW)

(21) Appl. No.: 16/357,029

(22) Filed: Mar. 18, 2019

(30) Foreign Application Priority Data
May 18, 2018 (TW) 107206556

(51) Int. Cl. B25B 7/16; B25B 7/02

(52) U.S. Cl. CPC B25B 7/16; B25B 7/02

(57) ABSTRACT

Universal pliers contains: a first jaw, a second jaw, a first lever, a second lever, and a connection extension. The first jaw and the second jaw are rotatably connected, the first lever is one-piece formed on the first jaw, the second lever is rotatably connected on the second jaw, a first end of the actuation extension is rotatably connected on the second lever, a second end of the actuation extension is rotatably connected in the first lever, and the actuation extension includes a bending section. The first lever includes a slide block and a spring which are accommodated on the first lever, a first side of the slide block abuts against the actuation extension, a first end of the spring is biased against a second side of the slide block, and a bottom of the first lever is screwed with a screw bolt which contacts with the spring.

### FIELD OF THE INVENTION

The present invention relates to universal pliers which contain the first jaw and the first lever one-piece formed so that the first jaw clamps the object with the second jaw exactly.

### BACKGROUND OF THE INVENTION

Needle-nose pliers (also known as pointy-nose pliers, long-nose pliers, pinch-nose pliers or snipe-nose pliers) are both cutting and holding pliers used by artisans, jewellery designers, electricians, network engineers and other tradesmen to bend, re-position and snip wire. Their namesake long nose gives excellent control while the cutting edge near the pliers' joint provides “one-tool” convenience. Because of their long shape they are useful for reaching into small areas where cables or other materials have become stuck or unreachable with fingers or other means.

Conventional needle-nose pliers are disclosed in TW Patent No. 148579 and contain a body and a jaw assembly, wherein the body has a column, and the jaw assembly has a through orifice. The body is connected with the jaw assembly by screwing a screw bolt with a nut. The screw bolt has two-way screw sections, and the nut is conical so as to screw with the screw bolt, thus connecting the body and the jaw assembly.

However, the width of the jaw assembly cannot be adjustable freely.

The present invention has arisen to mitigate and/or obviate the afore-described disadvantages.

### SUMMARY OF THE INVENTION

The primary aspect of the present invention is to provide universal pliers which contain the first jaw and the first lever one-piece formed so that the first jaw clamps the object with the second jaw exactly.

Further aspect of the present invention is to provide universal pliers in which the width between the first jaw and the second jaw of the universal pliers is adjustable so as to clamp the object accurately.

Another aspect of the present invention is to provide universal pliers by which the first jaw and the second jaw clamp the object after releasing the first lever and the second lever.

To obtain the above mentioned aspects, universal pliers provided by the present invention contain: a first jaw, a second jaw, a first lever, a second lever, and a connection extension.

The first jaw and the second jaw are rotatably connected at a fulcrum position closer to one end of the first lever and the second lever, the first lever is one-piece formed on a bottom of the first jaw, and the second lever is rotatably connected on an outer side of a bottom of the second jaw. A space between the first lever and the second lever is hollow, a first end of the actuation extension is rotatably connected on an inner surface of the second lever, a second end of the actuation extension is rotatably connected in an inner surface of the first lever, and the actuation extension includes a bending section.

The first lever includes a slide block and a spring which are accommodated on the first lever, a first side of the slide block abuts against the second end of the actuation extension, a first end of the spring is biased against a second side of the slide block, and a bottom of the first lever is screwed with a screw bolt which contacts with a second end of the spring.

Preferably, the first jaw and the second jaw include a serrated clamping face formed on an inner surface of the first jaw and the second jaw, an arcuate cutout is defined on a position of the serrated clamping face of the first jaw, and a cutting section is defined between the bottom of the first jaw and the bottom of the second jaw.

Preferably, the first jaw and the first lever are one-piece formed.

### BRIEF DESCRIPTION OF THE DRAWINGS

FIG. 1 is a perspective view showing the assembly of universal pliers according to a preferred embodiment of the present invention.

FIG. 2 is a perspective view showing the exploded components of the universal pliers according to the preferred embodiment of the present invention.

FIG. 3 is a cross sectional view showing the operation of the universal pliers according to the preferred embodiment of the present invention.

FIG. 4 is another cross sectional view showing the operation of the universal pliers according to the preferred embodiment of the present invention.

FIG. 5 is a side plan view showing the operation of a part of the universal pliers according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

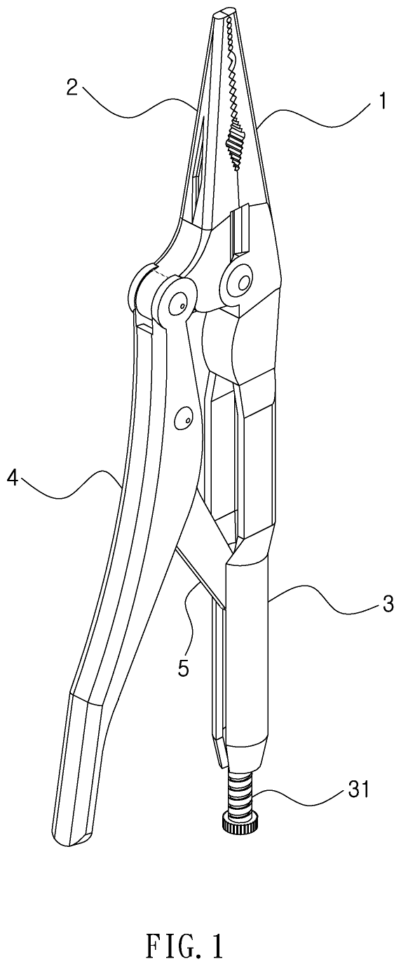

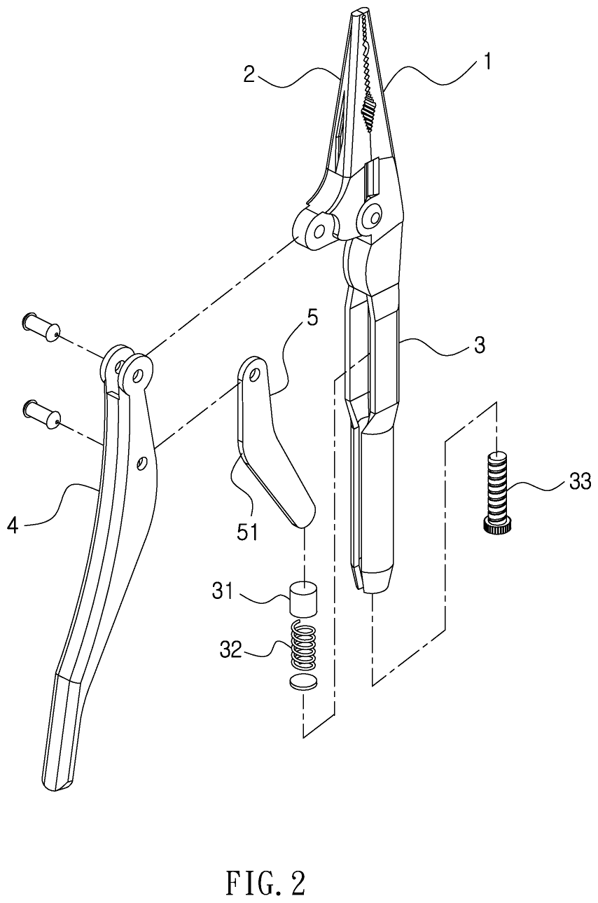

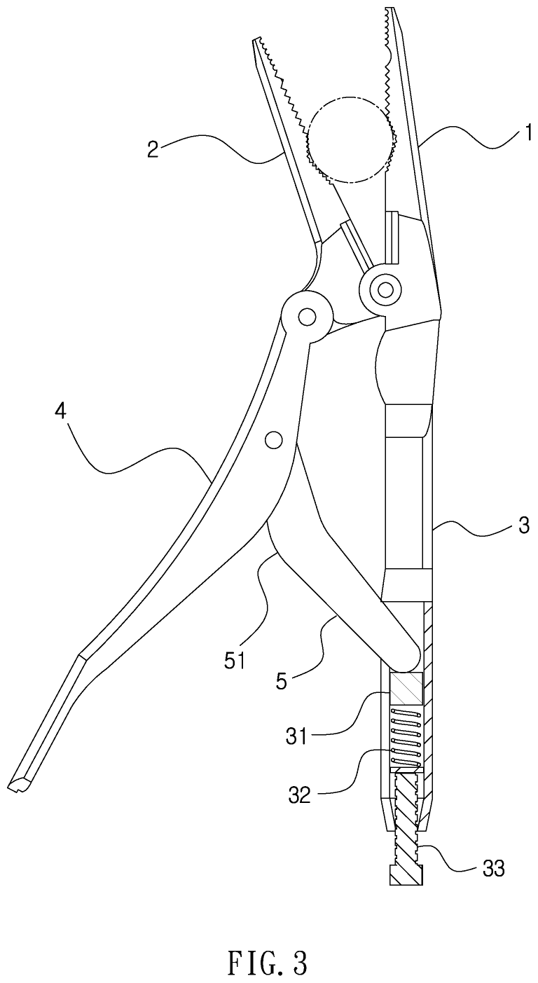

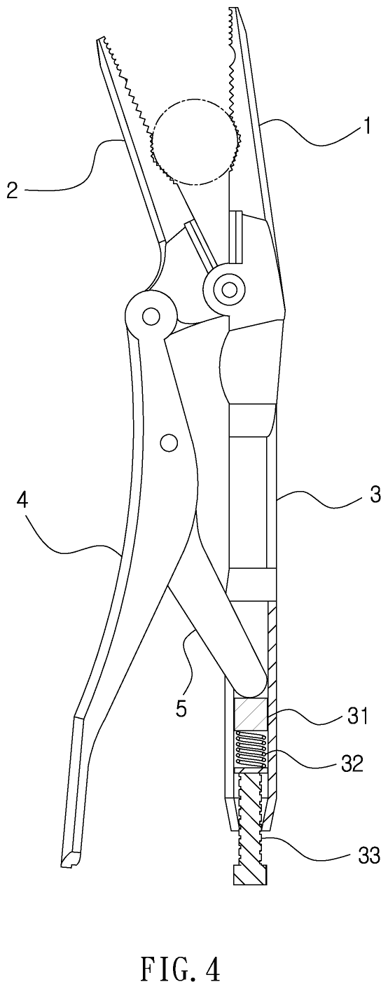

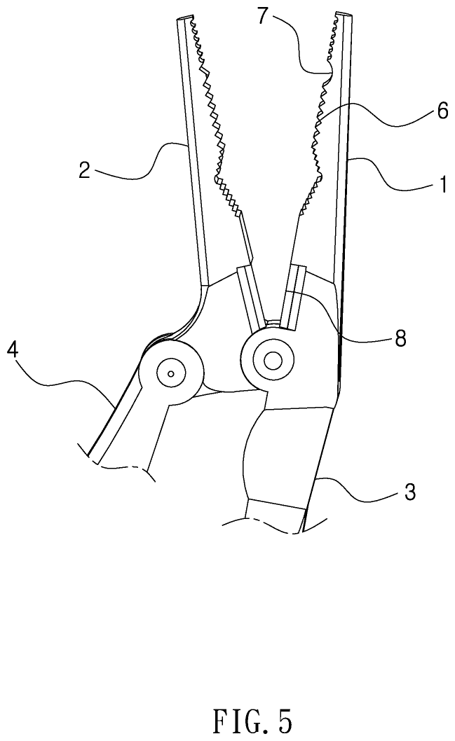

With reference to FIGS. 1-5, universal pliers according to a preferred embodiment of the present invention comprise: a first jaw 1, a second jaw 2, a first lever 3, a second lever 4, and a connection extension 5. In this embodiment, the universal pliers are needle-nose pliers.

The first jaw 1 and the second jaw 2 are rotatably connected at a fulcrum position closer to one end of the first lever 3 and the second lever 4, the first lever 3 is one-piece formed on a bottom of the first jaw 1, the second lever 4 is rotatably connected on an outer side of a bottom of the second jaw 2, wherein a space between the first lever 3 and the second lever 4 is hollow, a first end of the actuation extension 5 is rotatably connected on an inner surface of the second lever 4, a second end of the actuation extension 5 is rotatably connected in an inner surface of the first lever 3, and the actuation extension 5 includes a bending section 51.

The first lever 3 includes a slide block 31 and a spring 32 which are accommodated on the first lever 3, a first side of the slide block 31 abuts against the second end of the actuation extension 5, a first end of the spring 32 is biased against a second side of the slide block 31, and a bottom of the first lever 3 is screwed with a screw bolt 33 which contacts with a second end of the spring 32.

The screw bolt 33 is rotated to control an angle between the actuation extension 5 and the second lever 4. For example, when the screw bolt 33 is screwed into the first lever 3, the actuation extension 5 is horizontal, and when the screw bolt 33 is removed from the first lever 3, the actuation extension 5 is vertical, thus adjusting a width between the first jaw 1 and the second jaw 2. When the first jaw 1 and the second jaw 2 clamp an object and the first lever 3 and the second lever 4 are pressed, the actuation extension 5 pushes the slide block 31 to press the spring 32, and the bending section 51 of the actuation extension 5 abuts against the inner surface of the second lever 4 so that the spring 32 forces the slide block 31 to engage with the actuation extension 5, and the first jaw 1 and the second jaw 2 clamp the object. The second lever 4 is rotatably connected with the actuation extension 5 and the second jaw 2, and a top of the bending section 51 is rotatably connected with the second lever 4, thus clamping or releasing the object by using the first lever 4, the actuation extension 5, the second jaw 2, and the bending section 51.

The first jaw 1 and the second jaw 2 include a serrated clamping face 6 formed on an inner surface of the first jaw 1 and the second jaw 2, an arcuate cutout 7 is defined on a position of the serrated clamping face 6 of the first jaw 1, and a cutting section 8 is defined between the bottom of the first jaw 1 and the bottom of the second jaw 2.

The first jaw 1 and the first lever 3 are one-piece formed so that the first jaw 1 clamps the object with the second jaw 2 exactly.

Accordingly, the width between the first jaw 1 and the second jaw 2 of the universal pliers is adjustable so as to clamp the object accurately. Preferably, the first jaw 1 and the second jaw 2 clamp the object after releasing the first lever 3 and the second lever 4.

While various embodiments in accordance with the present invention have been shown and described, it is clear to those skilled in the art that further embodiments may be made without departing from the scope of the present invention.

What is claimed is:

1. Universal pliers comprising:
a first jaw, a second jaw, a first lever, a second lever, and a connection extension;
wherein the first jaw and the second jaw are rotatably connected at a fulcrum position closer to one end of the first lever and the second lever, the first lever is formed on a bottom of the first jaw, and the second lever is rotatably connected on an outer side of a bottom of the second jaw, wherein a space between the first lever and the second lever is hollow, a first end of the actuation extension is rotatably connected on an inner surface of the second lever, a second end of the actuation extension is rotatably connected in an inner surface of the first lever, and the actuation extension includes a bending section;
wherein the first lever includes a slide block and a spring which are accommodated on the first lever, a first side of the slide block abuts against the second end of the actuation extension, a first end of the spring is biased against a second side of the slide block, and a bottom of the first lever is screwed with a screw bolt which contacts with a second end of the spring.

2. The universal pliers as claimed in claim 1, wherein the first jaw and the second jaw include a serrated clamping face formed on an inner surface of the first jaw and the second jaw, an arcuate cutout is defined on a position of the serrated clamping face of the first jaw, and a cutting section is defined between the bottom of the first jaw and the bottom of the second jaw.

3. The universal pliers as claimed in claim 1, wherein the first jaw and the first lever are one-piece formed.
